(19) United States
(12) Patent Application Publication
(10) Pub. No.: US 2012/0228859 A1
(43) Pub. Date: Sep. 13, 2012

(54) V-Shaped Cardboard Structure Addendum for Toilet Paper Rolls

(76) Inventor: Warren A. STOBBE, Parker, CO (US)

(21) Appl. No.: 13/329,578

(22) Filed: Dec. 19, 2011

Related U.S. Application Data
(60) Provisional application No. 61/451,349, filed on Mar. 10, 2011.

(51) Int. Cl. B42D 15/00

(52) U.S. Cl. 283/56

(57) ABSTRACT

The v-shaped cardboard structure add-on for existing toilet paper rolls combines two unusual systems into one creating a better product that is beneficial for companies and consumers. The first system in the v-shaped cardboard structure add-on for existing toilet paper rolls is a physical control (utilitarian) system function that stops the excessive unrolling of toilet paper. The second is a combined product delivery and marketing system (including advertising) that allows companies to reach their target markets in the most unexpected of ways. The v-shaped cardboard structure add-on for existing toilet paper rolls comprises of a wing and a pouch. The wing comprises of a plurality of perforated lines and a plurality of faces. The wing is folded in a v-like shape and is able to fit into a standardized core of a toilet paper.

The current application claims a priority to the U.S. Provisional Patent application Ser. No. 61/423,776 filed on Dec. 16, 2010 and the U.S. Provisional Patent application Ser. No. 61/451,349 filed on Mar. 10, 2011.

### FIELD OF THE INVENTION

The present invention relates to a combination of a physical control system within the core of toilet tissue that prevents ‘roller run’ and the use of said system to create a new method of marketing and product delivery.

### PRIOR ART

All prior art pertaining to roller run has focused solely on external hardware apparatus and expensive dispensers. Many go beyond the simple need of just stopping roller run cost-effectively. None have considered the empty core as a means of solving this issue. Further, no one has yet to develop a multifaceted system within a roll of toilet paper that provides for utilitarian functionality and product marketing and delivery.

### BACKGROUND OF THE INVENTION

Currently, the core of the toilet paper is being used solely to hold the sheets on a roll of toilet paper. The core does not help in any way to prevent the unrolling of tissue, which is a common household problem. The present invention creates a previously non-existing use for the core. The present invention is composed of two mutually exclusive parts that operate and function as one. The first is a utilitarian process that stops the continuous unrolling of toilet tissue, which is commonly referred to as “roller run”. The second is a specialized product delivery system that incorporates the physical properties of the first process, but additionally, provides a platform from which this unique system of delivery of product and marketing can inform the consumer about new products, discounts on existing brands, coupon redemptions, cross referencing of other proprietary brands, and value added incentives. Together, the two subsystems provide a novel system of communicating, creating value, and giving notice to timely savings and promotions on paper and consumer products purchased by the audience that uses them.

### SUMMARY OF THE INVENTION

The present invention addresses two inter-connected applications. The first consists of preventing the uncontrollable roll out of toilet tissue, which is not a current function for the standard design of toilet paper rolls. The next application is a product delivery and marketing (including advertising) system that delivers coupons and various product promotions to a consumer every time a new toilet paper roll is installed on the respective dispenser, be it a spindle or roller. There can be many variations regarding the shape and size of the coupons that will be used, as that depends on the desires of the manufacturer and their respective ad agency. Also, there are a variety of ways (i.e. packaging systems) in which the coupons come with the toilet paper.

### BRIEF DESCRIPTION OF THE DRAWINGS

FIG. 1 is a perspective view of an unfolded wing.

FIG. 2 is a perspective view of a folded wing.

FIG. 3 is a perspective view of a packaging system in which the wing is attached to an end of a toilet paper roll.

FIG. 4 is a perspective view of a packaging system in which the wing is preinstalled in a toilet paper roll.

FIG. 5 is a perspective view of a disassembled packaging system in which the wing is already installed in a toilet paper roll.

FIG. 6 is a front plan view of a packaging system in which the wing is inside of a pouch.

### DETAIL DESCRIPTIONS OF THE INVENTION

All illustrations of the drawings are for the purpose of describing selected versions of the present invention and are not intended to limit the scope of the present invention.

An on-going issue with the current method of dispensing toilet paper is the lack of ability to control the extra unrolling of toilet paper. This is an important issue because it can become a frustrating task for many consumers to control the roll out of toilet paper. Further, it is wasteful, costly, an unnecessary nuisance and source of irritation for the consumer. Also, a consideration for many is the impression of an unkempt and unclean bathroom. One of the objectives of the present invention is to create a better bathroom experience. Another important objective of this invention is to provide an innovative method of marketing, which includes but is not limited to, advertisements and packaging, (for manufacturers and/or distributors) and savings for the consumer. Further, the design of the present invention creates an innovative platform for displaying various ads, promotions, communications, and coupons for any participating company. Also, it further provides the manufacturer with a new product delivery system that benefits the consumer through discounted product purchases and coupon redemptions to be used at a retailer.

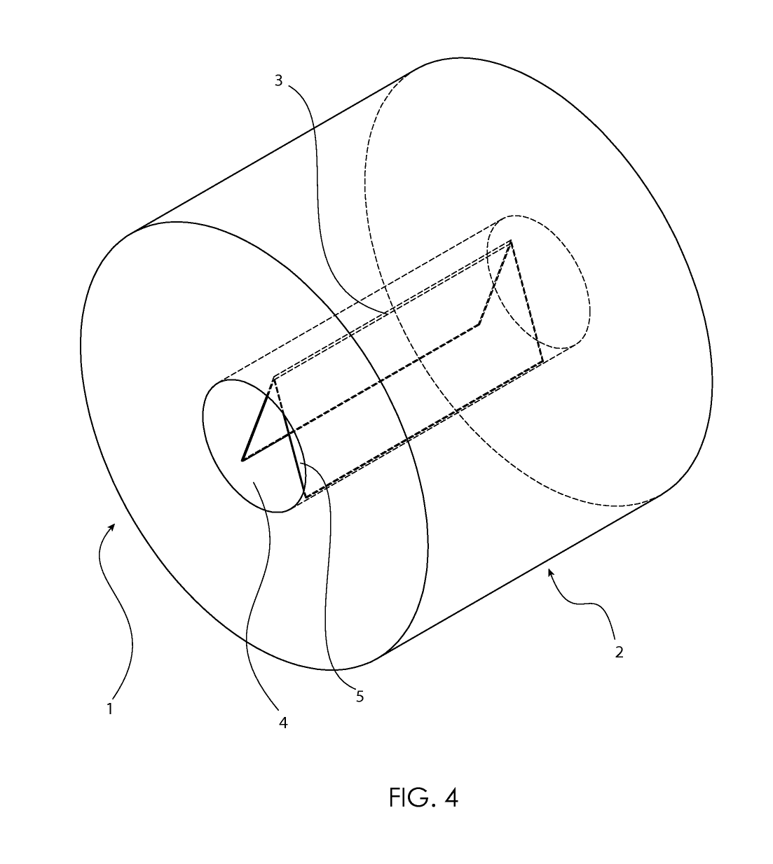

In reference FIG. 4, the present invention, herein referred to as the roll-stop sto'away system or sto'away system, is versatile in its implementation because it is designed to work with existing tissue dispensers, including, but not limited to, spindles and rollers. The sto'away system is a simple insert for existing rolls of toilet paper. Since each core 4 (the cardboard cylinder inside the sheets of toilet paper) of toilet paper 2 is the same size regardless of the toilet paper brand or how many extra sheets of toilet paper are on the core 4, the sto'away system will work in conjunction with all varieties, brands, and types of toilet paper.

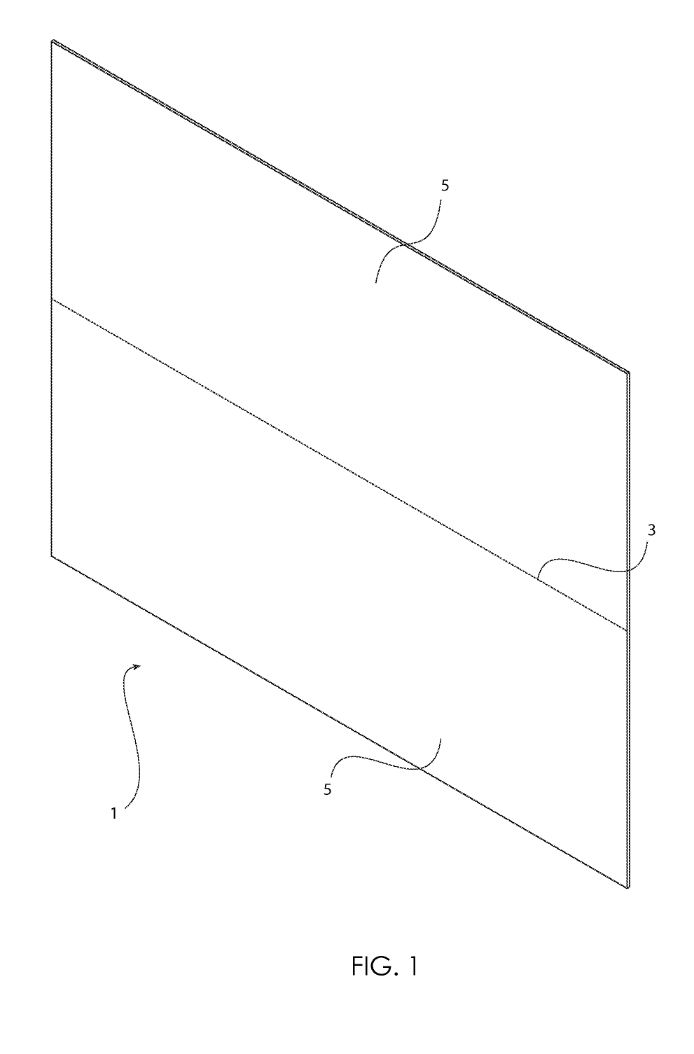

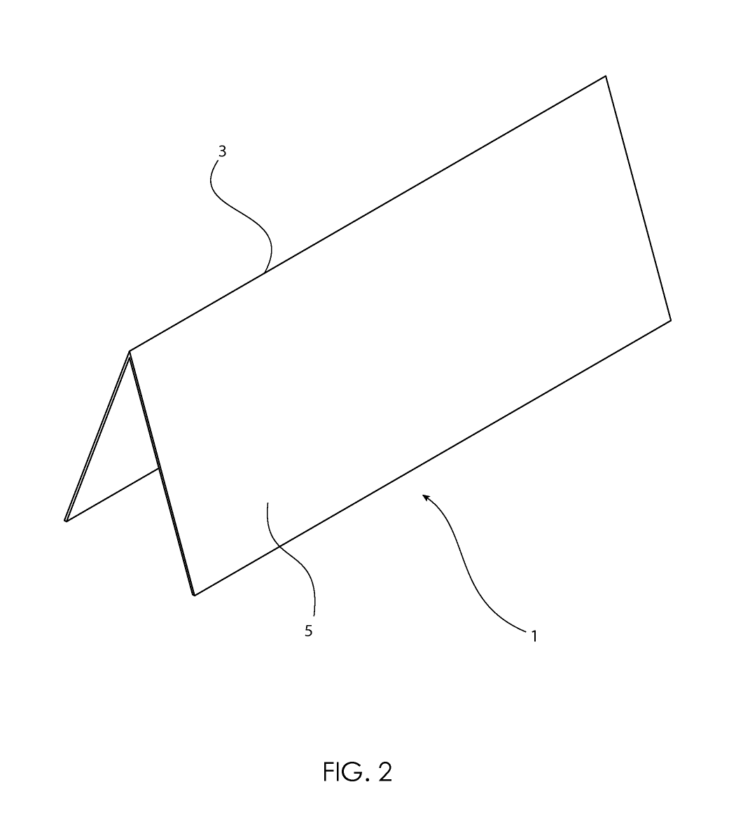

Referring to FIG. 1 and FIG. 2, since there is a standardization of the size of the core 4, the dimensions of the wing 1, when folded into its ‘v’ shape, can also be standardized. The wing 1 is made up of a plurality of perforated lines 3 that spans across the entire wing 1 and a plurality of faces 5 on which the different advertisements are displayed. In the present embodiment of the sto'away system, the wing 1 contains only one perforated line 3, which is also a center perforated line 3, running across the center of the wing 1, creating two identical faces 5. Also, in the present embodiment, the wing 1 is made of a thin, flexible piece of cardboard material. However, the material that can be used is not limited to lightweight cardboard alone. Any other sturdy, yet lightweight material can be used to create the wing 1. Unfolded, the present embodiment of the wing 1 is measured to be three inches by three and three-fourths inches. The center perforated line 3 of the plurality of perforated lines 3 enables the wing 1 to flex and bend to create a ‘v’ shape to correctly fit into the core 4. As of now, the total advertising space, which is provided by the faces 5, available is eleven and a quarter inches per side of the wing 1 with a total of twenty-two and a half inches (with a maximum possibility of twenty four inches) of ad space. If designed correctly, there can be many different types of advertisements, including, but not limited to, coupons or special deals and promotions displayed on a single wing 1. The dimensions mentioned for the current embodiment are for wings that only need a single fold at a center perforated line 3 to create the required ‘v’ shape. The wing 1 can in fact be much larger than the size of the present embodiment. For larger wings 1, more perforated lines 3 are needed so the wing 1 can be folded more than once until it resembles the same ‘v’ shape as the present embodiment. It is important that the wing 1 maintains and remains consistent with the shape and size of its ‘v’ so the wing 1 can be inserted into the core 4 while retaining enough space to rotate around the spindle or roller. The ‘v’ shape is non-concentric and counter-balanced so it produces an uneven rotational motion while the roll 2 is being dispensed. As a result, the wing 1 positioned within the core 4 of the toilet paper roll 2 will cause the spindle or roller to come to a rest at the open end of the ‘v’ as tension of the roll 2 of tissue is released. The free fall of tissue is most prevalent particularly when the roll 2 is being rotated (i.e. pulled on) and approximately half or more of the roll is used. The ‘v’ shape of the wing 1 creates a counter-balancing effect because it is able to slow down the rotation of the toilet paper roll 2 and thus stop from excessive toilet paper being unrolled.

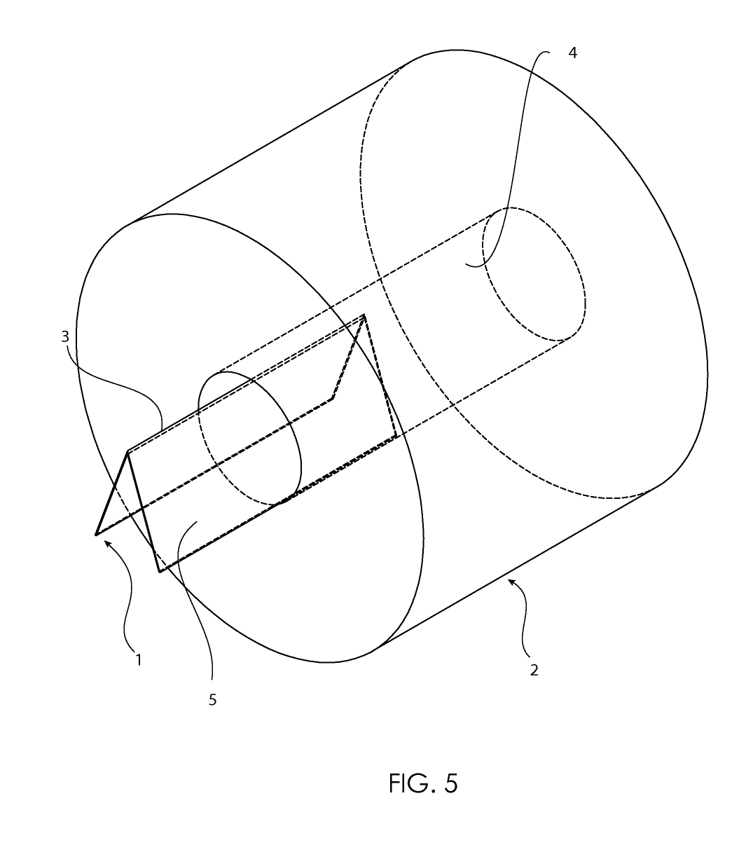

In reference to FIG. 4 and FIG. 5, the sto'away system will remain hidden until the consumer chooses to pull it out of the toilet paper roll 2. Although the advertisements and promotions displayed on the wing 1 can be colorful and eye catching, it may not be something that the consumer wishes to display in his or her bathroom. There is no worry of the advertisements being viewed continuously because the wing 1 is not in sight when using the toilet paper roll 2, since the wing 1 remains within the roll 2 until the consumer decides otherwise.

In reference to FIG. 1, FIG. 2, FIG. 5, the sto'away system is very simple in its design and as a result can be assembled very easily. This is important because it ensures that anyone can use this product without worrying about complicated installation instructions. The most basic of wings 1, as used in the present embodiment, only needs to be folded once at a center perforated line 3 of the plurality of perforated lines 3, which is pre-determined by the manufacturers of the sto'away system. After the wing 1 is folded and shaped into a ‘v,’ it can be inserted into the core 4. After, the entire roll 2 can be inserted onto the spindle or roller just as it would have without the sto'away system.

In reference to FIG. 1 and FIG. 2, another equally important objective of the sto'away system is its advertising and marketing system. In essence, the sto'away system is a vehicle for product promotions and advertisement. The wing 1 comprises of a plurality of faces 5 on which various messages can be displayed. The ideal marketing ideas are coupon redemptions, cross-referencing products, campaign addendums, value connected incentives, new product introductions, transfers of dissimilar products of the same company or subsidiary, promotional discounting, advertising, internet tie-ins, and target branding. The faces 5 can be customized to whatever layout design the company decides to implement, which can affect how many coupons can be used. Also, the sto'away system will be periodically updated so as to add more relevant (i.e. popular) products and coupon dates to ensure that the consumer is receiving the best deal at the time.

In reference to FIG. 2, FIG. 4, FIG. 5, a benefit of the sto'away system is that the consumer will have no choice but to see the coupons, regardless of whether he or she wants them or not. The wing 1 can be packaged in such a way that there is no choice but to see it. The first possible packaging application of the sto'away system is having the wing 1 pre-installed into the core 4 of the toilet paper roll 2. This would need to be done when the toilet paper rolls 2 are being manufactured. It also relieves the consumer from having to assemble the folded wing 1. The first packaging application relies on the consumer's natural curiosity. The concept is similar to finding a prize inside a bag of chips or cereal by relying on the need to discover something new and different, which can often prove to be an effective marketing strategy to generate interest in a product.

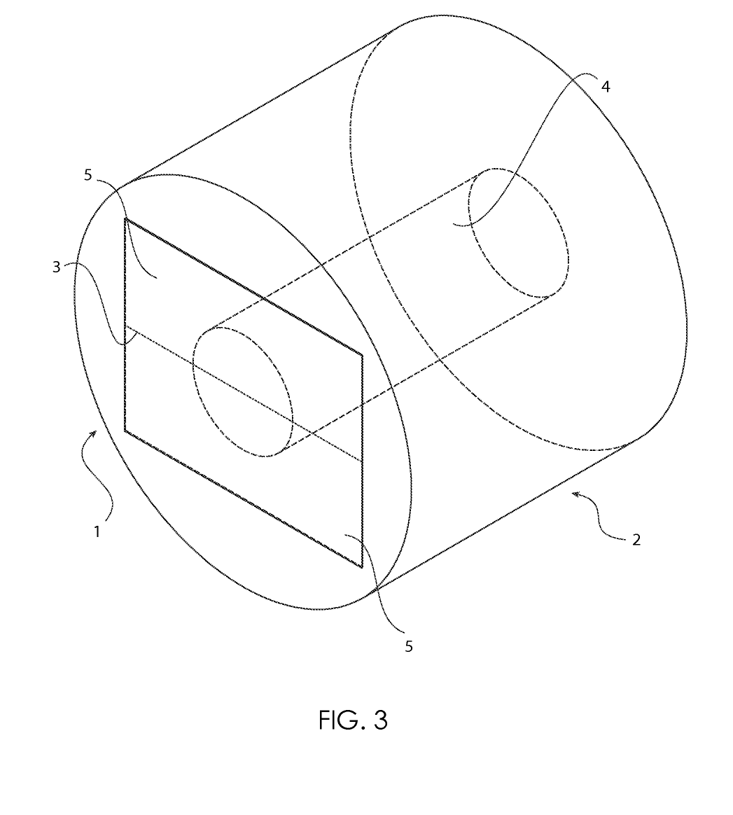

Referring to FIG. 2 and FIG. 3, the second possible packaging application is putting the wing 1 at the end of a toilet paper roll 2. With the wing 1 attached in this manner, the consumer is going to see the ads regardless of whether or not he or she wants to. This is because to even insert the toilet paper roll 2 into the dispenser, the wing 1 would have to be detached from the toilet paper roll 2, leading the consumer to see it. Then, the consumer would need to assemble the sto'away system by folding the wing 1 at the perforated center line(s) 3. The consumer is exposed to the ads during the entire time he or she is assembling the sto'away system, which is ample time to get the consumer interested in the product being advertised on the faces 5.

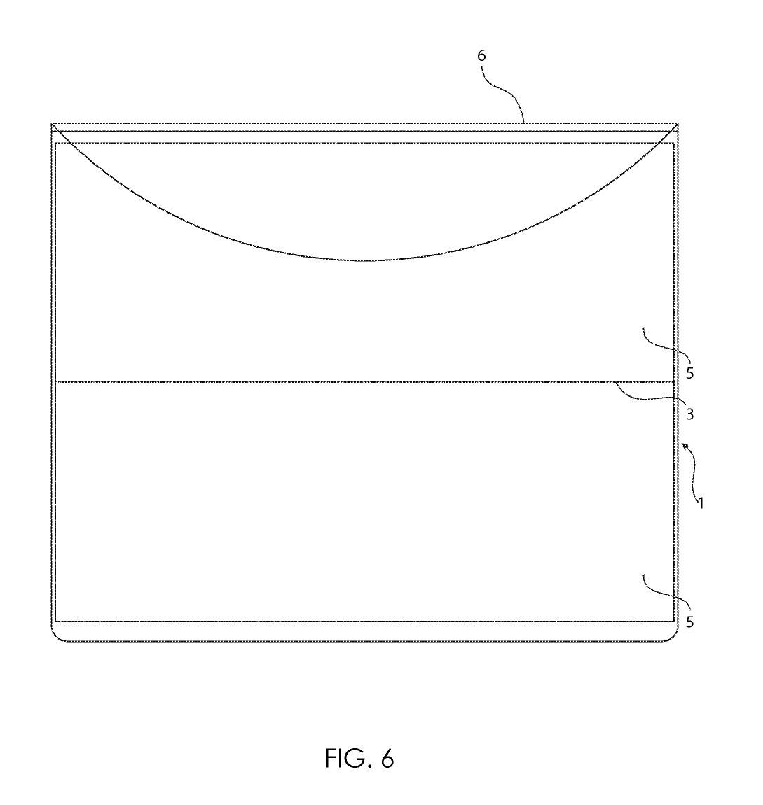

In reference to FIG. 1 and FIG. 6, the third packaging application involves a pouch 6 that holds the wing 1 as opposed to having it attached to the toilet paper roll 2. In this packaging application it is left up to the consumer to avail one's self to the sto'away system or not. The benefit of the pouch 6 is that it can contain several wing inserts with diverse promotions, coupons, and product selections. This offers more choice, and conveniently provides for several bathrooms throughout the home, available for anyone, regardless of whether a manufacturer of the toilet paper roll 2 would like to implement the use of the sto'away system or not. Also, the pouch 6, being contained within the packaging itself, can be designed to be aesthetically pleasing which will catch the attention of a consumer and lead to the purchase of the product or service presented by the sto'away system.

There are many benefits to using the sto'away system for both companies and consumers. Companies choosing to use the sto'away system are able to participate in a new form of marketing and product delivery. The sto'away system provides a platform of advertising in which a company can market their products easily, giving them an edge over their competition. Also, since toilet paper is a necessity for all households, companies will be able to target a variety of demographics to market their products. This can help to not only raise awareness of a product or service, but also create new target markets through cross-referencing affiliate companies, their products, and contribute to their growth.

Benefits to the consumer are mostly economic. The advertising and marketing component of the sto'away system can provide a consumer with a variety of promotions, ads, coupons, and vouchers. The coupons are useful because they can be redeemed for savings on products that are most likely used daily in most households. The consumer can apply these benefits and added value to their budget and, thereby creating a pathway to saving money, particularly for those who struggle to maintain their home or their daily needs.

Referring to FIG. 3, other benefits of the sto'away system include its cost-effectiveness. The material of the sto'away system is lightweight yet sturdy and stable enough to maintain its ‘v’ shape. Many different materials can be used for the construction of the wing 1, the only constraint is that it must be a recyclable product (made of recyclable materials) so as not to add to the build up or waste of materials. Also, since the material is sturdy, the sto'away system is not a product that has to be gently handled, which adds to the durability of the product. In many instances, the toilet paper roll 2 can be mishandled because of vigorous pulling of the toilet paper. The benefit of the sto'away system is that it can withstand a lot of the wear that the toilet paper roll 2 would be subjected to without the danger of the sto'away system becoming too damaged to work properly. Since the sto'away system is durable, it can even be re-used if the consumer only has one or does not wish to use the coupon just yet, or even if the consumer wishes to only benefit from the physical application of the sto'away system (stopping the runoff of toilet paper). If the manufacturer chose to go with the material of the present embodiment (thin cardboard) then the cost of creating these wings 1 would be negligible.

Another cost-effective benefit of the product is its ability to include as many coupons as a company wants. As mentioned, the size of the wing 1 can be expanded yet still be able to fit into the core 4. This is possible because the wing 1 simply needs to be a certain size to be inserted into the core 4. Initially, before the wing 1 is folded, the wing 1 can be much larger than the size previously mentioned. The only adjustment for a larger wing 1 is that more folds would be required to obtain the same ‘v’ shape as in the present embodiment (which does not change in size). Also, a larger wing 1 would make the sto'away system even sturdier and stronger because of the added layers of material from the numerous folds.

Another unique aspect of the sto'away system is its non-traditional form of communication and product characterization. The present invention provides companies with a direct method of communicating to an audience in a non-conventional manner, which can prove to be a productive marketing strategy at minimal cost to the company. Also, the sto'away system contributes to the ever-changing independence (freedom) of the business environment and paper product delivery alternatives.

The sto'away system can also be used to expand the horizons of new and trending media (social media included) sites. Websites and organizations dedicated to bringing their customers daily deals and coupons, such as LivingSocial and Groupon, can easily use the sto'away system to advertise their company. This is beneficial to these companies because their success relies heavily on their target market's need to save money, which is also a driving concept for the sto'away system. The present invention lends itself to the possibility of reaching millions of customers who are looking for savings. Other sites, like social media networks such as Facebook, Twitter, and LinkedIn, are able to advertise their website on the sto'away system as a new form of marketing.

Although the invention has been explained in relation to its preferred embodiment, it is to be understood that many other possible modifications and variations can be made without departing from the spirit and scope of the invention as hereinafter claimed.

What is claimed is:

1. A v-shaped cardboard structure add-on for existing toilet paper rolls comprises,
a wing;
a pouch;
the wing comprises of a plurality of perforated lines and a plurality of faces;
the plurality of perforated lines horizontally placed across the wing;
the plurality of faces defined by the plurality of perforated lines;
a plurality of faces displaying a plurality of advertisements;
the wing folded at a center perforated line of the plurality of perforated lines to define a v-like shape; and
wherein the wing is attached to an end of a toilet paper roll or the wing is inserted into the pouch.

2. A method for using the v-shaped cardboard structure add-on for existing toilet paper rolls comprises,
folding the wing along a center perforated line of the plurality of perforated
lines to define the v-like shape; and
inserting the wing into a core wherein the core is a standardized cardboard tube of a toilet paper roll.

3. A v-shaped cardboard structure add-on for existing toilet paper rolls comprises,
a wing;
a pouch;
the wing comprises of a plurality of perforated lines and a plurality of faces;
the plurality of perforated lines horizontally placed across the wing;
the plurality of faces defined by the plurality of perforated lines;
a plurality of faces displaying a plurality of advertisements;
the wing folded at a center perforated line of the plurality of perforated lines to define a v-like shape;
the wing being inserted into the pouch;
folding the wing along a center perforated line of a plurality of perforated lines to define the v-like shape; and
inserting the wing into a core wherein the core is a standardized cardboard tube of a toilet paper roll.
